(19) United States
(12) Patent Application Publication
(10) Pub. No.: US 2023/0334308 A1
(43) Pub. Date: Oct. 19, 2023

(54) DEEP REINFORCEMENT LEARNING FOR SKILL RECOMMENDATION

(71) Applicant: Microsoft Technology Licensing, LLC, Redmond, WA (US)

(72) Inventors: Chujie Zheng, Foster City, CA (US); Sufeng Niu, Fremont, CA (US); Xiao YAN, Sunnyvale, CA (US); Qidu He, Sunnyvale, CA (US); Jaewon YANG, Sunnyvale, CA (US); Yanen LI, Foster City, CA (US); Yiming WANG, Sunnyvale, CA (US)

(21) Appl. No.: 17/719,740

(22) Filed: Apr. 13, 2022

(51) Int. Cl. G06N 3/08; G06N 3/04; G06Q 50/00

(52) U.S. Cl. CPC G06N 3/08; G06N 3/0472; G06Q 50/01

(57) ABSTRACT

Techniques for using deep reinforcement learning for training a recommendation model for an online service are disclosed herein. In some embodiments, a computer-implemented method comprises training a recommendation model using deep reinforcement learning and a Markov decision process, where the Markov decision process has a state space including state embeddings of a plurality of reference users, an action space including action embeddings of the plurality of reference users, and a reward function. The reward function may be configured to issue a first reward based on current impression interaction data and a second reward based on a measurement of engagement of the reference user with the online service.

### TECHNICAL FIELD

The present application relates generally to using deep reinforcement learning for training a recommendation model for an online service.

### BACKGROUND

Online service providers, such as social networking services, e-commerce and marketplace services, photo sharing services, job hosting services, educational and learning services, and many others, typically require that each end-user register with the individual service to establish a user account. In most instances, a user account will include or be associated with a user profile—a digital representation of a person's identity. As such, a user profile may include a wide variety of information about the user, which may vary significantly depending upon the particular type and nature of the online service. By way of example, in the context of a social networking service, a user's profile may include information such as: first and last name, e-mail address, age, location of residence, a summary of the user's educational background, job history, and/or experiences, as well as individual skills possessed by the user. A user profile may include a combination of structured and unstructured data. For example, whereas a user's age may be stored in a specific data field as structured data, other profile information may be inferred from a free form text field such as a summary of a user's experiences. Furthermore, while some portions of a user profile, such as an e-mail address, may be mandatory—that is, the online service may require the user to provide such information in order to register and establish an account—other portions of a user profile may be optional.

In many instances, the quality of the experience a user has with a particular online service may vary significantly based on the extent to which the user has provided information to complete his or her user profile. Generally, the more complete a user profile is, the more satisfied the user is likely to be with various features and functions of the online service. By way of example, consider the extent to which a user has listed in his or her profile for a professional social networking service the skills possessed by the user. In the context of an online service, a variety of content-related and recommendation services utilize various aspects of a user's profile information—particularly skills—for targeting users to receive various content and for generating recommendations. For example, a content selection and ranking algorithm associated with a news feed, which may be referred to as a content feed, or simply a feed, may select and/or rank content items for presentation in the user's personalized content feed based on the extent to which the subject matter of a content item matches the perceived interests of the user. Here, the user's perceived interests may be based at least in part on the skills that he or she has listed in his or her profile. Similarly, a job-related search engine and/or recommendation service may select and/or rank job postings for presentation to a user based in part on skills listed in a profile of the user. Finally, a recommendation service for online courses may generate course recommendations for a user based at least in part on the skills that the user lists in his or her profile. Accordingly, the value of these services to the user can be significantly greater when the user has completed his or her profile by adding his or her skills. Specifically, with a completed profile and accurate list of skills, the user is more likely to receive relevant information that is of interest to the user.

However, when certain profile information is made optional, there are a variety of reasons that a user may be hesitant to add such information to his or her end-user profile. First, a user may not appreciate the increased value that he or she will realize from the various online services when his or her profile is complete. Second, a user may not understand how to add certain information to his or her profile, or a user may simply not want to take the time to add the information to his or her user profile. Finally, it may be difficult for a user to understand specifically what information—for example, which skills—the end-user should add to his or her user profile. Accordingly, many online services prompt users to add information to their user profile. For example, in the context of a social networking service—particularly a professional social networking service—a profile completion service may prompt users to add skills to their respective user profiles.

Online services may use recommendation models to determine which skills to prompt users to add to their user profiles. Traditional recommendation models rely on supervised learning approaches. However, supervised learning requires significant pre-processing of data and vast amounts of computation, thereby increasing the amount of time required to train the corresponding recommendation models. As a result, the underlying computer system suffers from inefficiency. Furthermore, current recommendation models fail to effectively optimize long-termuser engagement, instead focusing on immediate user interaction, such as click-through-rates.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating functional components of an online service, in accordance with an example embodiment.

FIG. 2 illustrates a graphical user interface (GUI) in which a user may add one or more skills to a profile of the user, in accordance with an example embodiment.

FIG. 3 is a flowchart illustrating a method of using deep reinforcement learning for training a recommendation model for an online service, in accordance with an example embodiment.

FIG. 4 illustrates a GUI in which a profile of a user is displayed, in accordance with an example embodiment.

FIG. 5 illustrates a GUI of a job search application, in accordance with an example embodiment.

FIG. 6 illustrates a GUI of an online course application, in accordance with an example embodiment.

FIG. 7 is a block diagram illustrating a software architecture, in accordance with an example embodiment.

FIG. 8 illustrates a diagrammatic representation of a machine in the form of a computer system within which a set of instructions may be executed for causing the machine to perform any one or more of the methodologies discussed herein, in accordance with an example embodiment.

### DETAILED DESCRIPTION

I. Overview

Example methods and systems of using deep reinforcement learning for training a recommendation model for an online service are disclosed. In the following description, for purposes of explanation, numerous specific details are set forth in order to provide a thorough understanding of example embodiments. It will be evident, however, to one skilled in the art that the present embodiments may be practiced without these specific details.

The above-discussed technical problems of accuracy and efficiency are addressed by one or more example embodiments disclosed herein, in which a specially-configured computer system is configured to build a reinforcement learning-based suggested skills recommendation system to optimize long-term user engagement with an online service.

The term “state embedding” is used herein to refer to an embedding that is based on information about a state of a user. The state embedding may be based on profile data, activity data (e.g., user interactions with applications), and previous impression interaction data (e.g., previous user interactions with suggested skills). The term “action embedding” is used herein to refer to an embedding that is based on a current action of a user, which may be reflected in current impression interaction data that indicates a skill that has been selected by a recommendation model at a current time step for display to the user. The state embedding and the actions embedding will be discussed in further detail below

In some example embodiments, the computer system, for each reference user of a plurality of reference users of an online service, computes a state embedding for the reference user based on profile data of the reference user, activity data of the reference user, and previous impression interaction data of the reference user, where the activity data indicates interactions of the reference user with one or more applications of the online service, and the previous impression interaction data indicates interactions of the reference user with reference skills that have been selected by a recommendation model at one or more previous time steps for display to the reference user. The selected reference skills have been displayed along with selectable user interface elements configured to add the reference skills to the profile of the reference user. The computer system also, for each reference user of the plurality of reference users, computes an action embedding based on current impression interaction data of the reference user, where the current impression interaction data indicates a reference skill that has been selected by the recommendation model at a current time step for display to the reference user. The selected reference skill has been displayed along with a selectable user interface element configured to add the reference skill to the profile of the reference user. Next, the computer system trains a recommendation model using deep reinforcement learning and a Markov decision process, where the Markov decision process has a state space including the state embeddings of the plurality of reference users, an action space including the action embeddings of the plurality of reference users, and a reward function. The reward function is configured to issue a first reward based on the current impression interaction data indicating that the reference user selected the selectable user interface element displayed at the current time step, as well as a second reward based on a measurement of engagement of the reference user with the online service. Then, the computer system performs a function of the online service using the trained recommendation model.

The term “reference” is used herein to indicate data and entities being used or involved in the training of models. The term “target” is used herein to indicate data and entities being used or involved in the use of the trained models.

II. Detailed Example Embodiments

The methods or embodiments disclosed herein may be implemented as a computer system having one or more components implemented in hardware or software. For example, the methods or embodiments disclosed herein may be embodied as instructions stored on a machine-readable medium that, when executed by one or more hardware processors, cause the one or more hardware processors to perform the instructions.

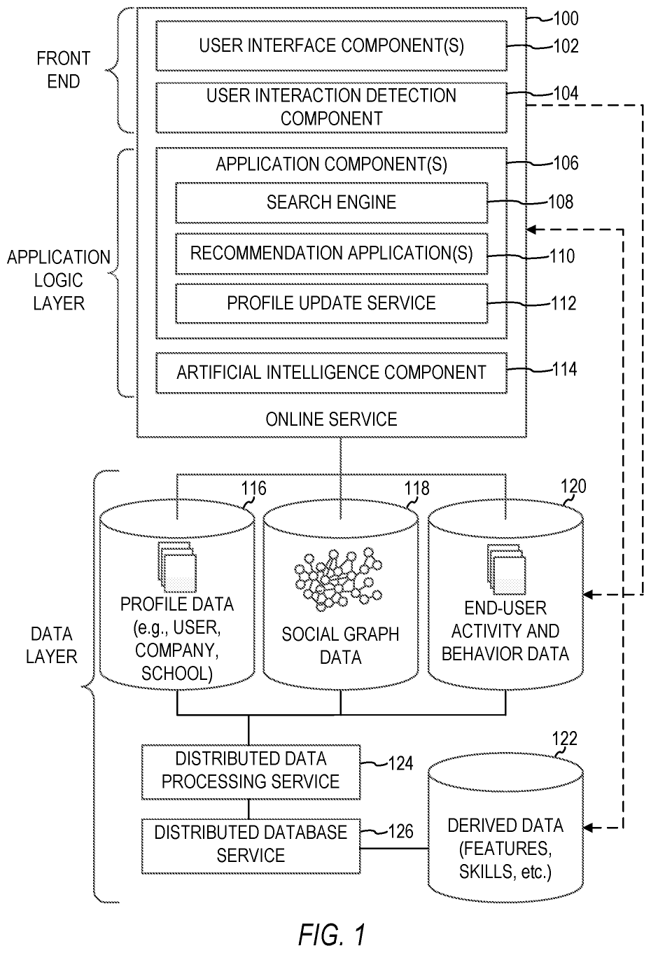

FIG. 1 is a block diagram illustrating functional components of an online service 100, in accordance with an example embodiment. As shown in FIG. 1, a front end may comprise one or more user interface components (e.g., a web server) 102, which receives requests from various client computing devices and communicates appropriate responses to the requesting client devices. For example, the user interface component(s) 102 may receive requests in the form of Hypertext Transfer Protocol (HTTP) requests or other web-based API requests. In addition, a user interaction detection component 104, sometimes referred to as a click tracking service, may be provided to detect various interactions that end-users have with different applications and services, such as those included in the application logic layer of the online service 100. As shown in FIG. 1, upon detecting a particular interaction, the user interaction detection component 104 logs the interaction, including the type of interaction and any metadata relating to the interaction, in an end-user activity and behavior database 120. Accordingly, data from this database 120 can be further processed to generate data appropriate for training one or more machine-learned models, and in particular, for training models to rank a set of skills for an end-user.

An application logic layer may include one or more application server components 106, which, in conjunction with the user interface component(s) 102, generate various user interfaces (e.g., web pages) with data retrieved from various data sources in a data layer. Consistent with some embodiments, individual application server components 106 implement the functionality associated with various applications and/or services provided by the online service 100. For instance, as illustrated in FIG. 1, the application logic layer includes a variety of applications and services to include a search engine 108, one or more recommendation applications 110 (e.g., a job recommendation application, an online course recommendation application), and a profile update service 112. The various applications and services illustrated as part of the application logic layer are provided as examples and are not meant to be an exhaustive listing of all applications and services that may be integrated with and provided as part of the online service 100. For example, although not shown in FIG. 1, the online service 100 may also include a job hosting service via which end-users submit job postings that can be searched by end-users, and/or recommended to other end-users by the recommendation application(s) 110. As end-user's interact with the various user interfaces and content items presented by these applications and services, the user interaction detection component 104 detects and tracks the end-user interactions, logging relevant information for subsequent use.

As shown in FIG. 1, the data layer may include several databases, such as a profile database 116 for storing profile data, including both end-user profile data and profile data for various organizations (e.g., companies, schools, etc.). Consistent with some embodiments, when a person initially registers to become an end-user of the online service, the person will be prompted by the profile update service 112 to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 116. Similarly, when a representative of an organization initially registers the organization with the online service 100, the representative may be prompted to provide certain information about the organization. This information may be stored, for example, in the profile database 116, or another database (not shown).

Once registered, an end-user may invite other end-users, or be invited by other end-users, to connect via the online service 100. A “connection” may constitute a bilateral agreement by the end-users, such that both end-users acknowledge the establishment of the connection. Similarly, with some embodiments, an end-user may elect to “follow” another end-user. In contrast to establishing a connection, the concept of “following” another end-user typically is a unilateral operation and, at least with some embodiments, does not require acknowledgement or approval by the end-user that is being followed. When one end-user follows another, the end-user may receive status updates relating to the other end-user, or other content items published or shared by the other end-user user who is being followed. Similarly, when an end-user follows an organization, the end-user becomes eligible to receive status updates relating to the organization as well as content items published by, or on behalf of, the organization. For instance, content items published on behalf of an organization that an end-user is following will appear in the end-user's personalized feed, sometimes referred to as a content feed or news feed. In any case, the various associations and relationships that the end-users establish with other end-users, or with other entities (e.g., companies, schools, organization) and objects (e.g., metadata hashtags (“#topic”) used to tag content items), are stored and maintained within a social graph in a social graph database 118.

As end-users interact with the various content items that are presented via the applications and services of the online service 100, the end-users' interactions and behaviors (e.g., content viewed, links or buttons selected, messages responded to, job postings viewed, etc.) are tracked by the user interaction detection component 104, and information concerning the end-users' activities and behaviors may be logged or stored, for example, as indicated in FIG. 1 by the end-user activity and behavior database 120.

Consistent with some embodiments, data stored in the various databases of the data layer may be accessed by one or more software agents or applications executing as part of a distributed data processing service 124, which may process the data to generate derived data. The distributed data processing service 124 may be implemented using Apache Hadoop® or some other software framework for the processing of extremely large data sets. Accordingly, an end-user's profile data and any other data from the data layer may be processed (e.g., in the background or offline) by the distributed data processing service 124 to generate various derived profile data. As an example, if an end-user has provided information about various job titles that the end-user has held with the same organization or different organizations, and for how long, this profile information can be used to infer or derive an end-user profile attribute indicating the end-user's overall seniority level or seniority level within a particular organization. This derived data may be stored as part of the end-user's profile or may be written to another database.

In addition to generating derived attributes for end-users' profiles, one or more software agents or applications executing as part of the distributed data processing service 124 may ingest and process data from the data layer for the purpose of generating training data for use in training various machine-learned models, and for use in generating features for use as input to the trained models. For instance, profile data, social graph data, and end-user activity and behavior data, as stored in the databases of the data layer, may be ingested by the distributed data processing service 124 and processed to generate data properly formatted for use as training data for training one of the aforementioned machine-learned models for ranking skills. Similarly, the data may be processed for the purpose of generating features for use as input to the machine-learned models when ranking skills for a particular end-user. Once the derived data and features are generated, they are stored in a database 122, where such data can easily be accessed via calls to a distributed database service 124.

In some example embodiments, the application logic layer of the online service 100 also comprises an artificial intelligence component 114 that is configured to use deep reinforcement learning for training a recommendation model to determine which skills to display to a user of the online service 100 as recommended skills to add to the profile of the user. For example, the artificial intelligence component 112 may use the trained recommendation model to select one or more skills, and then the profile update service 112 may prompt the user to add the selected one or more skills to the profile of the user.

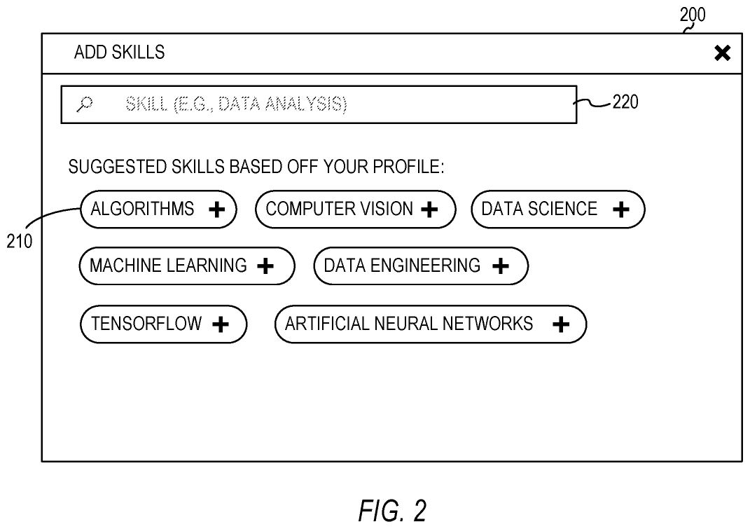

FIG. 2 illustrates a graphical user interface (GUI) 200 in which a user may add one or more skills to a profile of the user, in accordance with an example embodiment. In the example shown in FIG. 2, the profile update service 112 displays the GUI 200, including a corresponding selectable user interface element 210 for each one of the selected skills. In some example embodiments, the selectable user interface element 210 is configured to trigger storing of the corresponding skill as part of a profile of the user in response to a selection of the corresponding selectable user interface element 210. For example, selection of the selectable user interface element 210 of one of the skills may result in the skill being stored in the database 116 in association with the profile of the user.

The artificial intelligence component 114 is configured to build a recommendation model that is capable of improving users' long-term engagement with the online service 100 via deep reinforcement learning. Deep reinforcement learning is a subfield of machine learning that combines reinforcement learning and deep learning. Deep learning is a form of machine learning that utilizes a neural network to transform a set of inputs into a set of outputs via an artificial neural network. Reinforcement learning considers the problem of a computational agent learning to make decisions by trial and error. Deep reinforcement learning incorporates deep learning into the solution, allowing agents to make decisions from unstructured input data without manual engineering of the state space.

Unlike the traditional approaches to recommendation models that rely on supervised learning, the artificial intelligence component 114 formulates the recommendation model into a Markov Decision Process and implements a framework that can leverage reinforcement learning models. Reinforcement learning is a machine learning training method based on rewarding desired behaviors or punishing undesired ones. Unlike supervised learning, reinforcement learning does not require large amounts of labelled training data. In general, a reinforcement learning agent is able to perceive and interpret its environment, take actions and learn through trial and error. The artificial intelligence component 114 uses reinforcement learning to learn an optimal policy given an agent moving in an environment that is defined by the Markov Decision Process. In reinforcement learning, the learning agent learns an optimal policy that maximizes a reward function that accumulates from immediate rewards. The learning agent, which is implemented by the artificial intelligence component 114, interacts with an environment in discrete time steps, which are incremented after the learning agent takes an action, receives a reward, and the system (e.g., the environment and the agent) moves to a new state. Adopting reinforcement learning instead of supervised learning allows the artificial intelligence component 114 to optimize non-differentiable and indirect objectives, such as maximizing user engagement metrics or revenue. In this way, the artificial intelligence component improves both the instant metrics, such as click-through-rate, as well as long-term user engagement.

In some example embodiments, the artificial intelligence component 114 models the recommendation model as an agent that makes sequential decisions to maximize both users' immediate acceptance rate (e.g., user selection to add the recommended skills to the profile of the user) and long-term user engagement. In order to formulate the problem into a Markov Decision Process, the artificial intelligence component 114 uses three types of information to describe the state of users of the online service 100, including (1) users' profile information, (2) users' activity on the online service 100 (e.g., user interaction with one or more applications of the online service 100), and (3) users' interaction history with suggested skills. The artificial intelligence component 114 may treat users' selection of (e.g., clicking on) the recommended skills as the immediate reward, and users' engagement with the online service 100 (e.g., number of daily sessions) as the long-term reward. By implementing the proposed reinforcement learning framework, the goal of the recommendation model is to maximize both the immediate reward and the long-term reward.

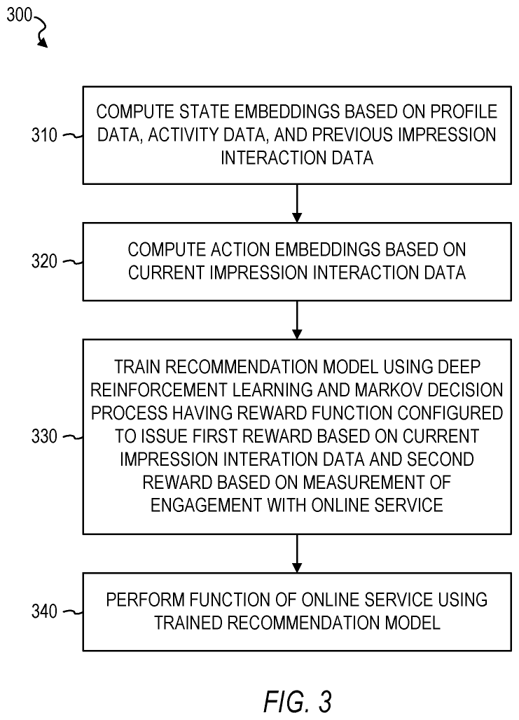

FIG. 3 is a flowchart illustrating a method 300 of using deep reinforcement learning for training a recommendation model for an online service, in accordance with an example embodiment. The method 300 can be performed by processing logic that can comprise hardware (e.g., circuitry, dedicated logic, programmable logic, microcode, etc.), software (e.g., instructions run on a processing device), or a combination thereof. In one implementation, the method 300 is performed by the online service 100 of FIG. 1, or any combination of one or more of its components (e.g., the artificial intelligence component 114, the application component 106), as described above.

At operation 310, the online service 100, for each reference user of a plurality of reference users of an online service, computes a state embedding for the reference user based on profile data of the reference user, activity data of the reference user, and previous impression interaction data of the reference user. In some example embodiments, the profile data comprises at least one of a company, an educational institution, a job title, or one or more reference skills. However, other types of profile data are also within the scope of the present disclosure. For example, the profile data may comprise any of the data stored in the database 116 in FIG. 1.

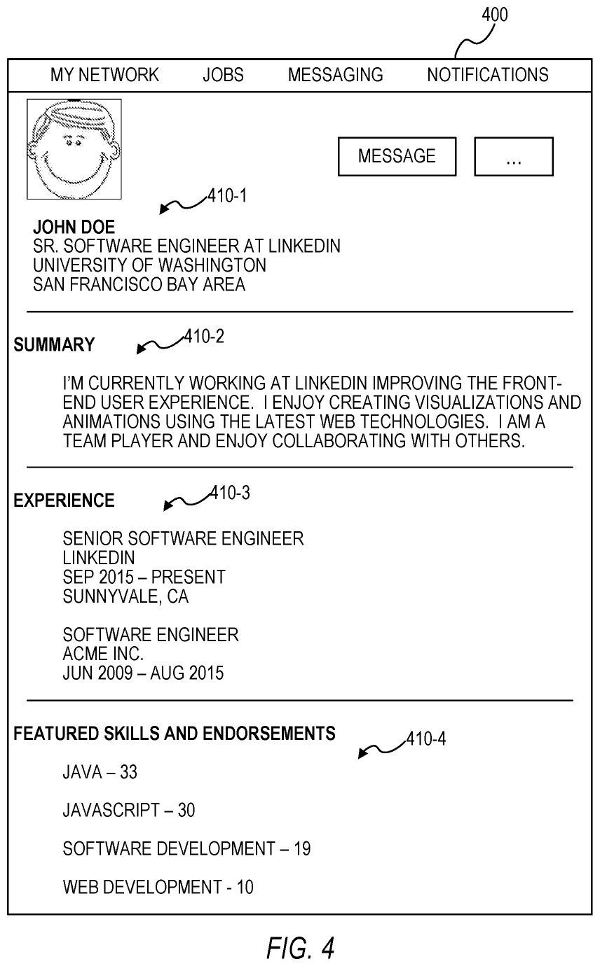

FIG. 4 illustrates a GUI 400 in which a profile of a user is displayed, in accordance with an example embodiment. The user profile displayed in the GUI 400 comprises profile data 410 of the user. In the example shown in FIG. 4, the profile data 410 includes headline data 410-1 identifying the user (e.g., photo and name), the user's current position at a particular organization, the user's current industry (not shown), and the user's current residential location, summary data 410-2, experience data 410-3, and featured skill and endorsement data 410-4 that identifies skills of the user along with a number of endorsements from other users for the skills of the user. The online service 100 may extract the profile data 410 from the user profile shown in FIG. 4.

The activity data indicates interactions of the reference user with one or more applications of the online service. The activity data may be retrieved from the database 120 in FIG. 1. In some example embodiments, the one or more applications of the online service comprise at least one of a job search application configured to present online job postings published on the online service, an online course application configured to present online courses published on the online service, and an online feed configured to present online content published on the online service. However, other types of applications of the online service are also within the scope of the present disclosure.

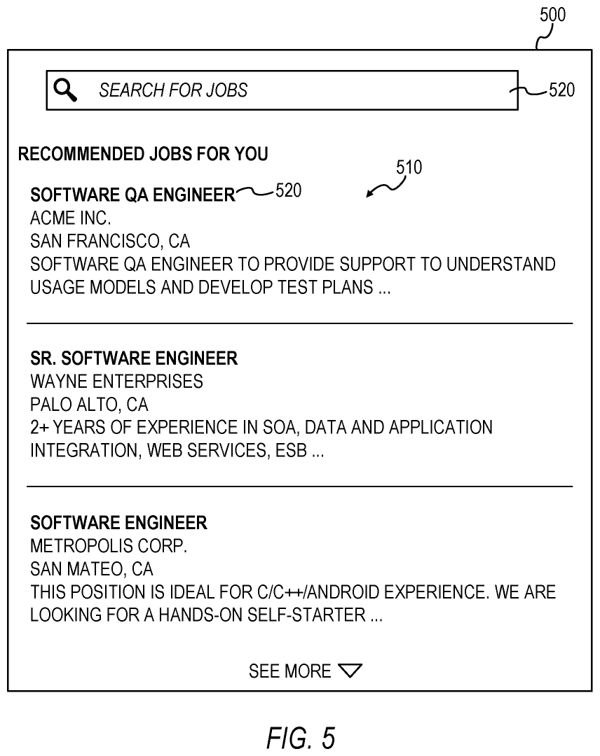

FIG. 5 illustrates a GUI 500 of a job search application, in accordance with an example embodiment. In some example embodiments, the recommendation application 110 displays a corresponding selectable user interface element 520 in association with an indication 510 of the online job postings on a computing device of the first user. The recommendation application 110 may determine which online job postings to recommend to the first user based on a relevance scoring algorithm that calculates a relevance score for each online job posting indicating a level of relevance of the online job posting to the user. The corresponding selectable user interface element 520 may be configured to, in response to its selection, trigger a display of the online job posting on the computing device of the user or initiate an online application process for the online job posting on the computing device of the user. The GUI 500 may also include a search field 520 configured to receive a search query from the user. In response to the search query, the search engine 108 may generate search results for the search query, such as by using the relevance scoring algorithm discussed above.

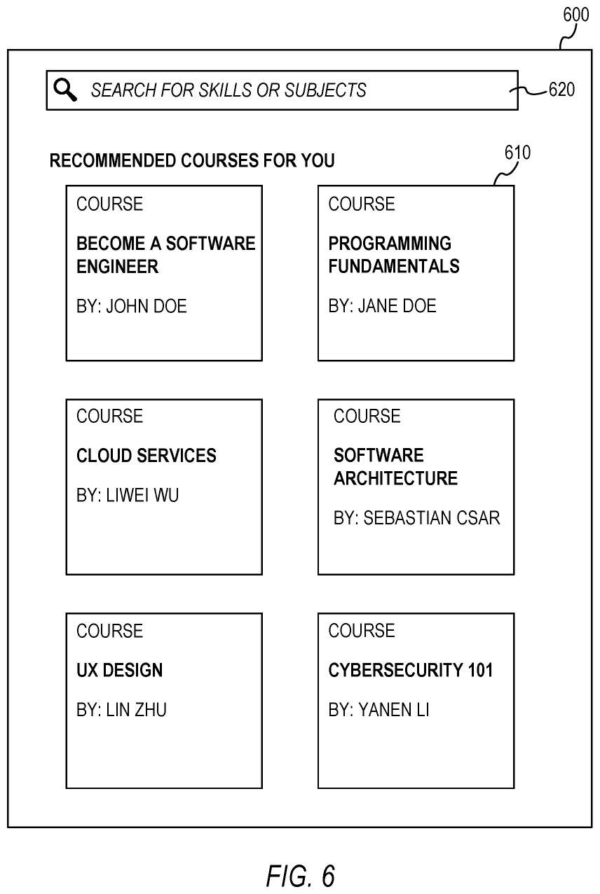

FIG. 6 illustrates a GUI 600 of an online course application, in accordance with an example embodiment. The recommendation application 110 may display a corresponding selectable user interface element 610 in association with an indication of an online course on a computing device of the user. The recommendation application 110 may determine which online courses to recommend to the user based on a relevance scoring algorithm that calculates a relevance score for each online course indicating a level of relevance of the online course to the user. The corresponding selectable user interface element 610 may be configured to, in response to its selection, trigger an online process for playing the online course on the computing device of the user. The GUI 600 may also include a search field 620 configured to receive a search query from the user. In response to the search query, the search engine 108 may generate search results for the search query, such as by using the relevance scoring algorithm discussed above.

The previous impression interaction data indicates interactions of the reference user with reference skills that have been selected by a recommendation model at one or more previous time steps for display to the reference user. The selected reference skills have been displayed along with selectable user interface elements configured to add the reference skills to the profile of the reference user. In some example embodiments, the previous impression interaction data identifies which reference skills were added to the profile of the reference user via user selection of the selectable user interface elements and which reference skills were not added to the profile of the reference user via user selection of the selectable user interface elements. For example, the previous impression interaction data may include a record of instances of the profile update service 112 displaying suggested skills, such as in FIG. 2, and which skills the user selected via corresponding selectable user interface elements 210 to add to the profile of the user, thereby identifying which suggested skills were added to the profile of the user via user selection of the selectable user interface elements 210 and which suggested skills were not added to the profile of the user via user selection of the selectable user interface elements 210.

At operation 320, the online service 100, for each reference user of the plurality of reference users, computes an action embedding based on current impression interaction data of the reference user. The current impression interaction data indicates a reference skill that has been selected by the recommendation model at a current time step for display to the reference user. The selected reference skill has been displayed along with a selectable user interface element configured to add the reference skill to the profile of the reference user.

At operation 330, the online service 100 trains a recommendation model using deep reinforcement learning and a Markov decision process. The Markov decision process has a state space including the state embeddings of the plurality of reference users, an action space including the action embeddings of the plurality of reference users, and a reward function. The reward function is configured to issue a first reward based on the current impression interaction data indicating that the reference user selected the selectable user interface element displayed at the current time step. The reward function is also configured to issue a second reward that comprises a long-term reward. In some example embodiments, the long-term reward is based on a measurement of engagement of the reference user with the online service.

In some example embodiments, the measurement of engagement of the reference user with the online service is based on a number of sessions the reference user has had with the online service 100 within a predetermined period of time, such as the total number of sessions the reference user has had with the online service 100 within a 24-hour period (e.g., total number of sessions per day). A session is an interaction between the reference user and the online service 100, where the reference user has loaded at least one page of the online service 100. The session is defined by continuous browsing of the online service 100 by the reference user within minimal time gaps between page views. For example, if no action is performed by the reference user within a defined period of time (e.g., within 30 minutes) after the page has been loaded, then the session ends.

In some example embodiments, the recommendation model is trained using Q-learning and a deep convolutional neural network. Q-learning is a model-free reinforcement learning algorithm to learn the value of an action in a particular state. It does not require a model of the environment (hence “model-free”), and it can handle problems with stochastic transitions and rewards without requiring adaptations. For any finite Markov decision process (FMDP), Q-learning finds an optimal policy in the sense of maximizing the expected value of the total reward over any and all successive steps, starting from the current state. Q-learning can identify an optimal action-selection policy for any given FMDP, given infinite exploration time and a partly-random policy. In one example embodiment, the recommendation model is trained using a Deep Q-Network (DQN). However, other types of deep convolutional neural networks are also within the scope of the present disclosure.

In some example embodiments, the recommendation model is trained using a policy gradient algorithm. A policy gradient algorithm is a type of reinforcement learning technique that relies upon optimizing parametrized policies with respect to the expected return (e.g., long-term cumulative reward) by gradient descent. It does not suffer from many of the problems that have been marring traditional reinforcement learning approaches, such as the lack of guarantees of a value function, the intractability problem resulting from uncertain state information, and the complexity arising from continuous states and actions. In some example embodiments, the recommendation model is trained using a Monte-Carlo policy gradient algorithm (e.g., REINFORCE). However, other types of policy gradient algorithms are also within the scope of the present disclosure.

At operation 340, the online service 100 performs a function of the online service 100 using the trained recommendation model. In some example embodiments, the performing the function of the online service using the trained recommendation model comprises selecting a target skill using the trained recommendation model, and displaying the target skill on a computing device of a target user of the online service along with a selectable user interface element configured to add the target skill to a profile of the target user. For example, the online service 100 may use the trained recommendation model to select which target skills to display in the GUI 200 of FIG. 2 as suggested skills to add the profile of a target user. Additionally or alternatively, the online service 100 may use the trained recommendation model to perform other functions of the online service 100 as well.

It is contemplated that any of the other features described within the present disclosure can be incorporated into the method 300.

Certain embodiments are described herein as including logic or a number of components or mechanisms. Components may constitute either software components (e.g., code embodied (1) on a non-transitory machine-readable medium or (2) in a transmission signal) or hardware-implemented components. A hardware-implemented component is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented component that operates to perform certain operations as described herein.

In various embodiments, a hardware-implemented component may be implemented mechanically or electronically. For example, a hardware-implemented component may comprise dedicated circuitry or logic that is permanently configured (e.g., as a special-purpose processor, such as a field programmable gate array (FPGA) or an application-specific integrated circuit (ASIC)) to perform certain operations. A hardware-implemented component may also comprise programmable logic or circuitry (e.g., as encompassed within a programmable processor) that is temporarily configured by software to perform certain operations. It will be appreciated that the decision to implement a hardware-implemented component mechanically, in dedicated and permanently configured circuitry, or in temporarily configured circuitry (e.g., configured by software) may be driven by cost and time considerations.

Accordingly, the term “hardware-implemented component” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented components are temporarily configured (e.g., programmed), each of the hardware-implemented components need not be configured or instantiated at any one instance in time. For example, where the hardware-implemented components comprise a processor configured using software, the processor may be configured as respective different hardware-implemented components at different times. Software may accordingly configure a processor, for example, to constitute a particular hardware-implemented component at one instance of time and to constitute a different hardware-implemented component at a different instance of time.

Hardware-implemented components can provide information to, and receive information from, other hardware-implemented components. Accordingly, the described hardware-implemented components may be regarded as being communicatively coupled. Where multiple of such hardware-implemented components exist contemporaneously, communications may be achieved through signal transmission (e.g., over appropriate circuits and buses) that connect the hardware-implemented components. In embodiments in which multiple hardware-implemented components are configured or instantiated at different times, communications between such hardware-implemented components may be achieved, for example, through the storage and retrieval of information in memory structures to which the multiple hardware-implemented components have access. For example, one hardware-implemented component may perform an operation, and store the output of that operation in a memory device to which it is communicatively coupled. A further hardware-implemented component may then, at a later time, access the memory device to retrieve and process the stored output. Hardware-implemented components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Similarly, the methods described herein may be at least partially processor-implemented. For example, at least some of the operations of a method may be performed by one or more processors or processor-implemented components. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a component, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

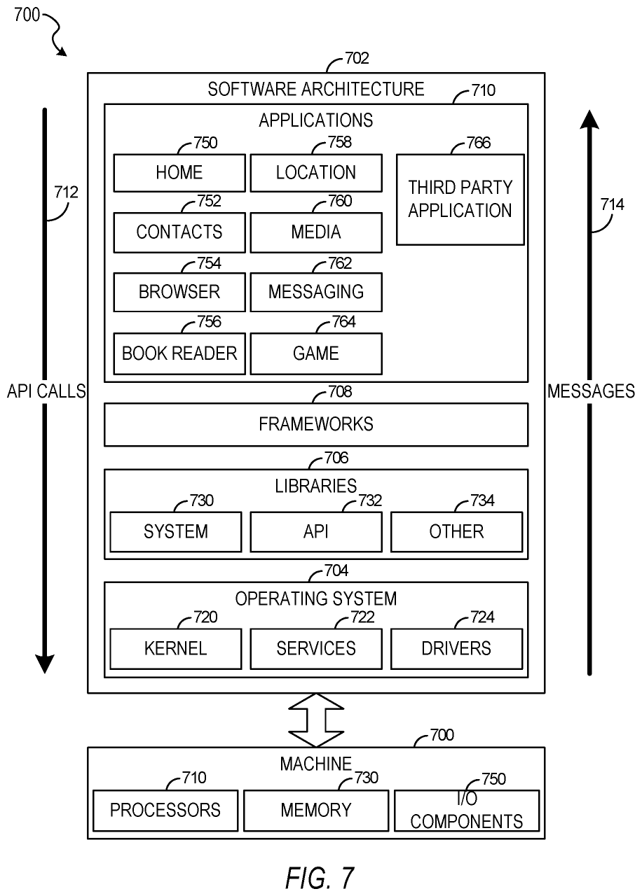

FIG. 7 is a block diagram 700 illustrating a software architecture 702, which can be installed on any one or more of the devices described above. FIG. 7 is merely a non-limiting example of a software architecture, and it will be appreciated that many other architectures can be implemented to facilitate the functionality described herein. In various embodiments, the software architecture 702 is implemented by hardware such as a machine 1200 of FIG. 12 that includes processors 710, memory 730, and input/output (I/O) components 750. In this example architecture, the software architecture 702 can be conceptualized as a stack of layers where each layer may provide a particular functionality. For example, the software architecture 702 includes layers such as an operating system 704, libraries 706, frameworks 708, and applications 710. Operationally, the applications 710 invoke API calls 712 through the software stack and receive messages 714 in response to the API calls 712, consistent with some embodiments.

In various implementations, the operating system 704 manages hardware resources and provides common services. The operating system 704 includes, for example, a kernel 720, services 722, and drivers 724. The kernel 720 acts as an abstraction layer between the hardware and the other software layers, consistent with some embodiments. For example, the kernel 720 provides memory management, processor management (e.g., scheduling), component management, networking, and security settings, among other functionality. The services 722 can provide other common services for the other software layers. The drivers 724 are responsible for controlling or interfacing with the underlying hardware, according to some embodiments. For instance, the drivers 724 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 706 provide a low-level common infrastructure utilized by the applications 710. The libraries 706 can include system libraries 730 (e.g., C standard library) that can provide functions such as memory allocation functions, string manipulation functions, mathematic functions, and the like. In addition, the libraries 706 can include API libraries 732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 706 can also include a wide variety of other libraries 734 to provide many other APIs to the applications 710.

The frameworks 708 provide a high-level common infrastructure that can be utilized by the applications 710, according to some embodiments. For example, the frameworks 708 provide various GUI functions, high-level resource management, high-level location services, and so forth. The frameworks 708 can provide a broad spectrum of other APIs that can be utilized by the applications 710, some of which may be specific to a particular operating system 704 or platform.

In an example embodiment, the applications 710 include a home application 750, a contacts application 752, a browser application 754, a book reader application 756, a location application 758, a media application 760, a messaging application 762, a game application 764, and a broad assortment of other applications, such as a third-party application 766. According to some embodiments, the applications 710 are programs that execute functions defined in the programs. Various programming languages can be employed to create one or more of the applications 710, structured in a variety of manners, such as object-oriented programming languages (e.g., Objective-C, Java, or C++) or procedural programming languages (e.g., C or assembly language). In a specific example, the third-party application 766 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 766 can invoke the API calls 712 provided by the operating system 704 to facilitate functionality described herein.

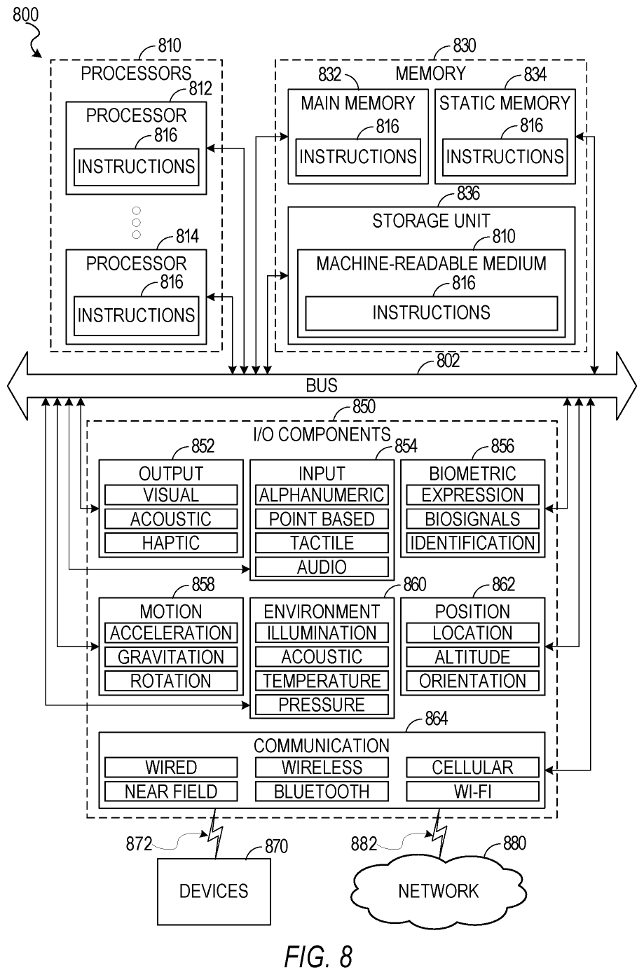

FIG. 8 illustrates a diagrammatic representation of a machine 800 in the form of a computer system within which a set of instructions may be executed for causing the machine 800 to perform any one or more of the methodologies discussed herein, according to an example embodiment. Specifically, FIG. 8 shows a diagrammatic representation of the machine 800 in the example form of a computer system, within which instructions 816 (e.g., software, a program, an application 810, an applet, an app, or other executable code) for causing the machine 800 to perform any one or more of the methodologies discussed herein may be executed. For example, the instructions 816 may cause the machine 800 to execute the method 300 of FIG. 3. Additionally, or alternatively, the instructions 816 may implement FIGS. 1-6, and so forth. The instructions 816 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a PC, a tablet computer, a laptop computer, a netbook, a set-top box (STB), a portable digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory 830, and I/O components 850, which may be configured to communicate with each other such as via a bus 802. In an example embodiment, the processors 810 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 812 and a processor 814 that may execute the instructions 816. The term “processor” is intended to include multi-core processors 810 that may comprise two or more independent processors 812 (sometimes referred to as “cores”) that may execute instructions 816 contemporaneously. Although FIG. 8 shows multiple processors 810, the machine 800 may include a single processor 812 with a single core, a single processor 812 with multiple cores (e.g., a multi-core processor), multiple processors 810 with a single core, multiple processors 810 with multiple cores, or any combination thereof.

The memory 830 may include a main memory 832, a static memory 834, and a storage unit 836, all accessible to the processors 810 such as via the bus 802. The main memory 832, the static memory 834, and the storage unit 836 store the instructions 816 embodying any one or more of the methodologies or functions described herein. The instructions 816 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 may include a wide variety of components to receive input, provide output, produce output, transmit information, exchange information, capture measurements, and so on. The specific I/O components 850 that are included in a particular machine 800 will depend on the type of machine 800. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion, and the grouping is in no way limiting. In various example embodiments, the I/O components 850 may include output components 852 and input components 854. The output components 852 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 850 may include biometric components 856, motion components 858, environmental components 860, or position components 862, among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 862 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a USB).

Moreover, the communication components 864 may detect identifiers or include components operable to detect identifiers. For example, the communication components 864 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 864, such as location via Internet Protocol (IP) geolocation, location via Wi-Fi® signal triangulation, location via detecting an NFC beacon signal that may indicate a particular location, and so forth.

The various memories (i.e., 830, 832, 834, and/or memory of the processor(s) 810) and/or the storage unit 836 may store one or more sets of instructions 816 and data structures (e.g., software) embodying or utilized by any one or more of the methodologies or functions described herein. These instructions (e.g., the instructions 816), when executed by the processor(s) 810, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 816 and/or data. The terms shall accordingly be taken to include, but not be limited to, solid-state memories, and optical and magnetic media, including memory internal or external to the processors 810. Specific examples of machine-storage media, computer-storage media, and/or device-storage media include non-volatile memory including, by way of example, semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 880 may be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data-transfer technology.

The instructions 816 may be transmitted or received over the network 880 using a transmission medium via a network interface device (e.g., a network interface component included in the communication components 864) and utilizing any one of a number of well-known transfer protocols (e.g., HTTP). Similarly, the instructions 816 may be transmitted or received using a transmission medium via the coupling 872 (e.g., a peer-to-peer coupling) to the devices 870. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 816 for execution by the machine 800, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method performed by a computer system having a memory and at least one hardware processor, the computer-implemented method comprising:
for each reference user of a plurality of reference users of an online service, computing an action embedding based on current impression interaction data of the reference user, the current impression interaction data indicating a reference skill that has been selected by a recommendation model at a current time step for display to the reference user, the selected reference skill having been displayed along with a selectable user interface element configured to add the reference skill to a profile of the reference user;
training a recommendation model using deep reinforcement learning and a Markov decision process, the Markov decision process having an action space and a reward function, the action space including the action embeddings of the plurality of reference users, the reward function configured to issue a first reward based on the current impression interaction data indicating that the reference user selected the selectable user interface element displayed at the current time step, the reward function also configured to issue a long-term reward that is different from the first reward; and
performing a function of the online service using the trained recommendation model.

2. The computer-implemented method of claim 1, further comprising:
for each reference user of the plurality of reference users of an online service, computing a state embedding for the reference user based on profile data of the reference user, activity data of the reference user, and previous impression interaction data of the reference user, the activity data indicating interactions of the reference user with one or more applications of the online service, the previous impression interaction data indicating interactions of the reference user with reference skills that have been selected by a recommendation model at one or more previous time steps for display to the reference user, the selected reference skills having been displayed along with selectable user interface elements configured to add the reference skills to the profile of the reference user,
wherein the Markov decision process has a state space including the state embeddings of the plurality of reference users.

3. The computer-implemented method of claim 1, wherein the profile data comprises at least one of a company, an educational institution, a job title, or one or more reference skills.

4. The computer-implemented method of claim 1, wherein the one or more applications of the online service comprise at least one of: a job search application configured to present online job postings, an online course application configured to present online courses published on the online service, or an online feed configured to present online content published on the online service.

5. The computer-implemented method of claim 1, wherein the previous impression interaction data identifies which reference skills were added to the profile of the reference user via user selection of the selectable user interface elements and which reference skills were not added to the profile of the reference user via user selection of the selectable user interface elements.

6. The computer-implemented method of claim 1, wherein the recommendation model is trained using Q-learning and a deep convolutional neural network.

7. The computer-implemented method of claim 1, wherein the recommendation model is trained using a policy gradient algorithm.

8. The computer-implemented method of claim 1, wherein the reward function is configured to issue the long-term reward based on a measurement of engagement of the reference user with the online service.

9. The computer-implemented method of claim 7, wherein the measurement of engagement of the reference user with the online service is based on a number of sessions the reference user has had with the online service within a predetermined period of time.

10. The computer-implemented method of claim 1, wherein the performing the function of the online service using the trained recommendation model comprises:
selecting a target skill using the trained recommendation model; and
displaying the target skill on a computing device of a target user of the online service along with a selectable user interface element configured to add the target skill to a profile of the target user.

11. A system comprising:
at least one hardware processor; and
a non-transitory machine-readable medium embodying a set of instructions that, when executed by the at least one hardware processor, cause the at least one hardware processor to perform operations, the operations comprising:
for each reference user of a plurality of reference users of an online service, computing an action embedding based on current impression interaction data of the reference user, the current impression interaction data indicating a reference skill that has been selected by a recommendation model at a current time step for display to the reference user, the selected reference skill having been displayed along with a selectable user interface element configured to add the reference skill to a profile of the reference user;
training a recommendation model using deep reinforcement learning and a Markov decision process, the Markov decision process having an action space and a reward function, the action space including the action embeddings of the plurality of reference users, the reward function configured to issue a first reward based on the current impression interaction data indicating that the reference user selected the selectable user interface element displayed at the current time step, the reward function also configured to issue a long-term reward that is different from the first reward; and
performing a function of the online service using the trained recommendation model.

12. The system of claim 11, wherein the operations further comprise:
for each reference user of the plurality of reference users of an online service, computing a state embedding for the reference user based on profile data of the reference user, activity data of the reference user, and previous impression interaction data of the reference user, the activity data indicating interactions of the reference user with one or more applications of the online service, the previous impression interaction data indicating interactions of the reference user with reference skills that have been selected by a recommendation model at one or more previous time steps for display to the reference user, the selected reference skills having been displayed along with selectable user interface elements configured to add the reference skills to the profile of the reference user,
wherein the Markov decision process has a state space including the state embeddings of the plurality of reference users.

13. The system of claim 11, wherein the profile data comprises at least one of a company, an educational institution, a job title, or one or more reference skills.

14. The system of claim 11, wherein the one or more applications of the online service comprise at least one of: a job search application configured to present online job postings, an online course application configured to present online courses published on the online service, or an online feed configured to present online content published on the online service.

15. The system of claim 11, wherein the previous impression interaction data identifies which reference skills were added to the profile of the reference user via user selection of the selectable user interface elements and which reference skills were not added to the profile of the reference user via user selection of the selectable user interface elements.

16. The system of claim 11, wherein the recommendation model is trained using Q-learning and a deep convolutional neural network.

17. The system of claim 11, wherein the recommendation model is trained using a policy gradient algorithm.

18. The system of claim 11, wherein the reward function is configured to issue the long-term reward based on a measurement of engagement of the reference user with the online service.

19. The system of claim 18, wherein the measurement of engagement of the reference user with the online service is based on a number of sessions the reference user has had with the online service within a predetermined period of time.

20. A non-transitory machine-readable medium embodying a set of instructions that, when executed by at least one hardware processor, cause the at least one hardware processor to perform operations, the operations comprising:
for each reference user of a plurality of reference users of an online service, computing an action embedding based on current impression interaction data of the reference user, the current impression interaction data indicating a reference skill that has been selected by a recommendation model at a current time step for display to the reference user, the selected reference skill having been displayed along with a selectable user interface element configured to add the reference skill to a profile of the reference user;
training a recommendation model using deep reinforcement learning and a Markov decision process, the Markov decision process having an action space and a reward function, the action space including the action embeddings of the plurality of reference users, the reward function configured to issue a first reward based on the current impression interaction data indicating that the reference user selected the selectable user interface element displayed at the current time step, the reward function also configured to issue a long-term reward that is different from the first reward; and
performing a function of the online service using the trained recommendation model.
